(19) United States
(12) Patent Application Publication
(10) Pub. No.: US 2022/0172220 A1
(43) Pub. Date: Jun. 2, 2022

(54) Methods and Systems for Generating a Conversational Flow

(71) Applicant: Verizon Patent and Licensing Inc., Basking Ridge, NJ (US)

(72) Inventors: Kiran Ladkat, Flower Mound, TX (US); Wei Wang, Frisco, TX (US)

(73) Assignee: Verizon Patent and Licensing Inc.

(21) Appl. No.: 17/110,148

(22) Filed: Dec. 2, 2020

(51) Int. Cl. G06Q 30/00; G06Q 10/10; G06N 20/00; G06F 3/14; G06F 40/30; H04L 12/58

(52) U.S. Cl. CPC G06Q 30/016; G06Q 10/10; H04L 51/02; G06F 3/14; G06F 40/30; G06N 20/00

(57) ABSTRACT

An illustrative conversational flow generation system adds a user intent to a conversational flow. Based on the user intent, the system determines a plurality of agent statements from a plurality of conversations. The system selects an agent statement from the plurality of agent statements and adds the agent statement to the conversational flow at a position sequentially prior to the user intent in the conversational flow. Corresponding methods and systems are also disclosed.

### BACKGROUND INFORMATION

Many businesses provide customer service to assist customers. Through a customer service channel provided by a business, a customer may interact with a customer service representative (e.g., to address an issue that the customer has with products and/or services provided by the business).

Some businesses rely on human customer representatives to provide customer service to customers. Other businesses implement automated assistants to provide customer service to customers. Such automated assistants may be in addition to or in lieu of human customer representatives.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative conversational flow generation system for generating a conversational flow according to embodiments described herein.

FIGS. 2A and 2B show an illustrative conversation between a user and a customer service agent according to embodiments described herein.

FIG. 3 shows an illustrative method for generating a conversational flow according to embodiments described herein.

FIG. 4 shows an illustrative method for determining an agent statement for a conversational flow according to embodiments described herein.

FIG. 5 shows an illustrative visual representation of a conversational flow according to embodiments described herein.

FIG. 6 shows an illustrative computing device according to embodiments described herein.

### DETAILED DESCRIPTION OF EXAMPLE EMBODIMENTS

Methods and systems for generating a conversational flow are described herein. In some embodiments, the conversational flow may represent a temporal structure of a conversation, such as a conversation between a customer service agent of a customer service channel provided by an organization and a user of the customer service channel. The conversational flow may include a sequence of various user intents corresponding to user statements made by the user and various agent statements made by the customer service agent.

In some embodiments, a generated conversational flow may be provided to a customer service agent for use by the customer service agent in conducting conversations with users of a customer service channel. As an example, a human customer service agent may reference the conversational flow to select agent statements to use in responding to user statements made in conversations. As another example, the conversational flow may be implemented in an automated customer service agent, and the automated customer service agent may automatically use agent statements in the conversational flow to respond to user statements made in conversations. In some embodiments, the conversational flow may be visually presented to a representative of an organization that provides customer service (e.g., a manager and/or an administrator of the organization) to facilitate evaluation of and/or adjustment to the conversational flow before the conversational flow is provided for use by a customer service agent.

The methods and systems described herein are capable of generating a conversational flow configured to facilitate an effective, efficient, and/or optimal conversation between a customer service agent and a user. In particular, to generate a conversational flow, the methods and systems may start from an end point of the conversational flow, and recursively select and add one or more agent statements and/or one or more user intents to the conversational flow until a start point of the conversational flow is reached. The methods and systems may select the one or more user intents and/or the one or more agent statements to be added the conversational flow based on one or more existing conversations. As an example, the methods and systems may add a user intent to the conversational flow. To determine an agent statement that will be the next statement added to the conversational flow, the methods and systems may determine a plurality of agent statements from a plurality of existing conversations based on the user intent, and select the agent statement from the plurality of agent statements. The methods and systems may then add the agent statement to the conversational flow at a position sequentially prior to the user intent in the conversational flow. The systems and methods may repeat these operations to continue to intelligently select and add user intents and agent statements to the conversational flow until a start point of the conversational flow is reached.

The methods and systems described herein may be advantageous in a number of technical respects. For example, by generating a conversational flow upwardly from an end point to a start point, a single conversational flow may be generated for each desired end point. This approach conserves time and computing resources by reducing the amount of time and computing resources needed to generate the conversational flow as compared to approaches in which a conversational flow is determined starting from the start point of the conversational flow and working downward to the end point of the conversational flow, which is typically more time-consuming and computationally expensive. Determining a conversational flow downwardly from a start point to an end point often results in a large number of candidate conversational flows being generated and usually requires a complicated evaluation of these candidate conversational flows to select one conversational flow to be used.

Moreover, the methods and systems described herein are capable of generating an optimal conversation flow configured to facilitate an effective and compact conversation between a customer service agent and a user of a customer service channel. When generating a conversational flow, for example, for each user intent in the conversational flow, the systems and methods may select the agent statement that directly led to the user intent in an existing conversation based on the quality of the existing conversation, and add the agent statement to the conversational flow at the position sequentially prior to the user intent. Thus, the methods and systems may select agent statements from high quality conversations (e.g., short conversations having positive user feedback) for the conversational flow, and therefore these agent statements may guide conversations to resolutions quickly and/or in a manner that facilitates a positive user experience. As a result, when communicating with a user based on the conversational flow, a customer service agent can quickly identify a resolving action to be performed to resolve an issue without irrelevant communication back and forth with the user. The customer service agent may therefore address an issue for the user in a short and effective conversation, and thus the user experience of the user and the efficiency of the customer service agent can be improved.

The methods and systems described herein may be especially advantageous for an automated customer service agent, such as an automated customer service agent that has limited conversational flexibility in communicating with the user. By following an optimal conversation flow generated by the methods and systems, the automated customer service agent can quickly identify a resolving action to be performed to practically address an issue for the user in an effective conversation without the need to transfer the user to a human customer service agent.

Various specific embodiments will now be described in detail with reference to the figures. It will be understood that the specific embodiments described below are provided as non-limiting examples of how various novel and inventive principles may be applied in various situations. Additionally, it will be understood that other examples not explicitly described herein may also be captured by the scope of the claims set forth below. Methods and systems described herein may provide any of the benefits mentioned above, as well as various additional and/or alternative benefits that will be described and/or made apparent below.

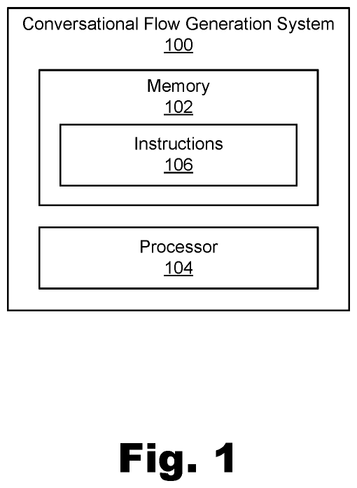

FIG. 1 shows an illustrative conversational flow generation system 100 (system 100) for generating a conversational flow. System 100 may be implemented by computer resources such as servers, processors, memory devices, storage devices, communication interfaces, and so forth. As shown, system 100 may include, without limitation, a memory 102 and a processor 104 selectively and communicatively coupled to one another. Memory 102 and processor 104 may each include or be implemented by computer hardware that is configured to store and/or execute computer software. Various other components of computer hardware and/or software not explicitly shown in FIG. 1 may also be included within system 100. In some examples, memory 102 and processor 104 may be distributed between multiple devices and/or multiple locations as may serve a particular implementation.

Memory 102 may store and/or otherwise maintain executable data used by processor 104 to perform any of the functionality described herein. For example, memory 102 may store instructions 106 that may be executed by processor 104. Memory 102 may be implemented by one or more memory or storage devices, including any memory or storage devices described herein, that are configured to store data in a transitory or non-transitory manner. Instructions 106 may be executed by processor 104 to cause system 100 to perform any of the functionality described herein. Instructions 106 may be implemented by any suitable application, software, code, and/or other executable data instance. Additionally, memory 102 may also maintain any other data accessed, managed, used, and/or transmitted by processor 104 in a particular implementation.

Processor 104 may be implemented by one or more computer processing devices, including general purpose processors (e.g., central processing units (CPUs), graphics processing units (GPUs), microprocessors, etc.), special purpose processors (e.g., application specific integrated circuits (ASICs), field-programmable gate arrays (FPGAs), etc.), or the like. Using processor 104 (e.g., when processor 104 is directed to perform operations represented by instructions 106 stored in memory 102), system 100 may perform various functions associated with generating a conversational flow in any manner described herein or as may serve a particular implementation.

As described in further detail below, system 100 may generate a conversational flow configured to facilitate an effective and/or efficient conversation between a customer service agent and a user of a customer service channel. Through a customer service channel provided by an organization (e.g., a company, a government agency, etc.), a user may participate in a conversation with a customer service agent to obtain assistance related to product(s) and/or service(s) provided by the organization. The customer service agent (also referred to herein as agent) may be a human agent, an automated agent (e.g., a chat bot), and/or a hybrid implementation of the human agent and the automated agent. In a hybrid implementation, the automated agent may conduct a conversation with a user seeking assistance with an issue. If the automated agent cannot identify and/or perform a resolving action (e.g., the automated agent does not have authority to perform the resolving action) to resolve the issue for the user, the automated agent may connect or transfer the user to a human agent to continue the conversation or start a new conversation with the user.

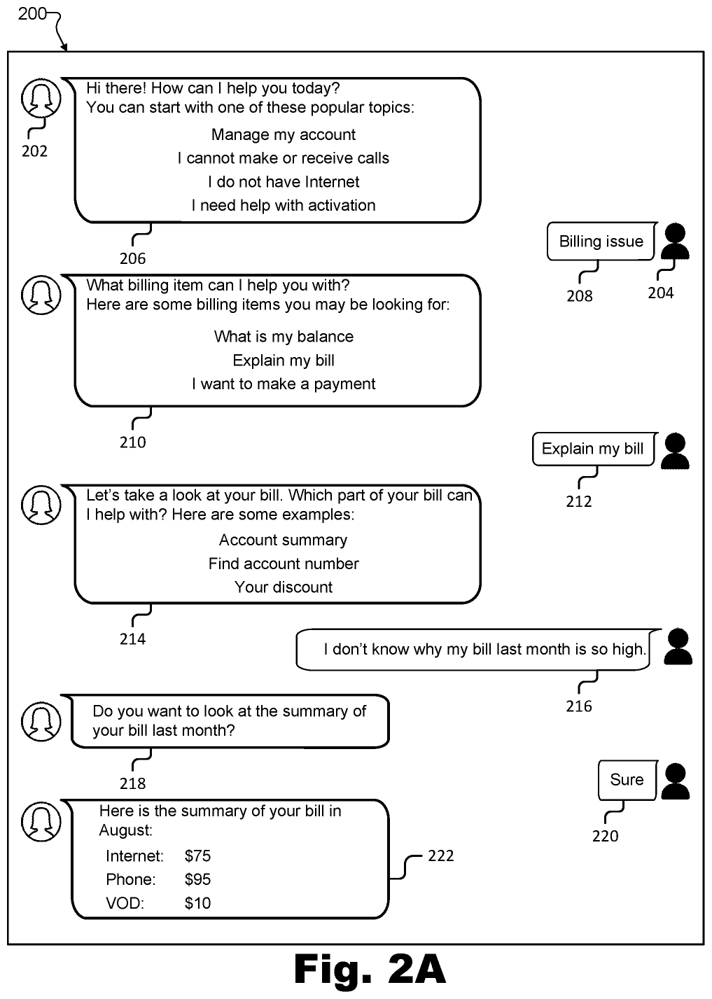

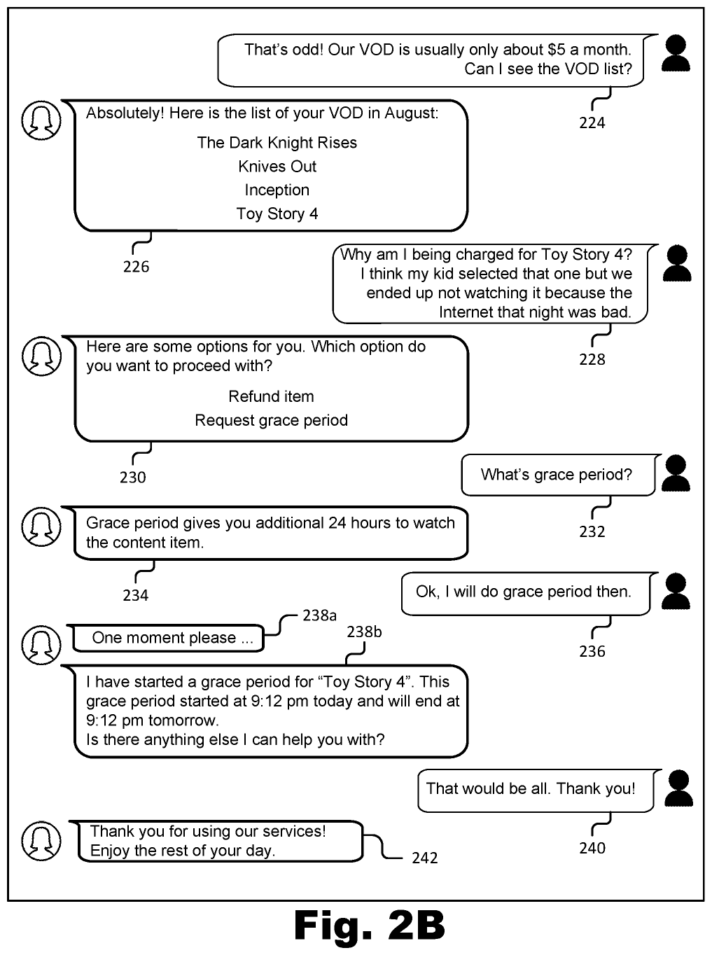

An example conversation is depicted in FIGS. 2A and 2B. As shown, FIGS. 2A and 2B illustrate a conversation 200 between a customer service agent 202 and a user 204. As depicted, the conversation 200 may include a sequence of agent statements 206, 210, 214, 218, 222, 226, 230, 234, 238, 242 made by the customer service agent 202 and user statements 208, 212, 216, 220, 224, 228, 232, 236, 240 made by the user 204. Each user statement and agent statement may include one or more assertions, questions, answers, definitions, requests, and/or other types of statements. For example, as depicted in FIG. 2A, the user 204 may state “Billing issue” as the user statement 208. As another example, as depicted in FIG. 2B, the agent statement 238 may include a first portion 238a in which the customer service agent 202 states “One moment please . . . ” and a second portion 238b in which the customer service agent 202 states:
I have started a grace period for “Toy Story 4.” This grace period started at 9:12 pm today and will end at 9:12 pm tomorrow. Is there anything else I can help you with?

The positioning of agent statements and user statements relative to one another in FIGS. 2A and 2B represent an order in which the statements are provided. As an example, agent statement 206 may be provided first, followed by user statement 208, followed by agent statement 210, and so on. As a specific example depicted in FIG. 2B, the customer service agent 202 may provide the agent statement 238 to respond to the user statement 236 (“Ok. I will do grace period then”) which was provided by the user 204 right before the agent statement 238. After the customer service agent 202 provides the agent statement 238, the user 204 may provide the user statement 240 (“That would be all. Thank you!”) to respond to the agent statement 238. Thus, as a customer service agent and a user continue to communicate with each other in a conversation, agent statements of the customer service agent and user statements of the user may be sequentially appended to the conversation in a chronological order that they occur. This chronological order from the beginning towards the end of the conversation may be referred to as the chronological order of the conversation. In some embodiments, when a first statement (e.g., an agent statement or a user statement) occurs directly prior to a second statement (e.g., a user statement or an agent statement) in a conversation without any user statement and/or agent statement in between, the first statement may be considered as being located sequentially prior (i.e., immediately prior in a chronological sense) to the second statement in the conversation, the second statement may be considered as being located sequentially subsequent (i.e., immediately subsequent in a chronological sense) to the first statement in the conversation, and the first statement and the second statement may be considered as being located sequentially adjacent (i.e., immediately adjacent in a chronological sense) to one another in the conversation. For example, in FIG. 2B, the agent statement 238 may be considered as being located sequentially prior to the user statement 240, the user statement 240 may be considered as being located sequentially subsequent to the agent statement 238, and the agent statement 238 and the user statement 240 may be considered as being located sequentially adjacent to one another in the conversation 200.

In some embodiments, an agent statement and a user statement that are located sequentially adjacent to one another in a conversation may form a dialog pair. Thus, a dialog pair may include a user statement of a user and an agent statement made by a customer service agent to respond to such user statement. For example, the user statement 208 and the agent statement 210 in the conversation 200 may form a dialog pair. Alternatively, a dialog pair may include an agent statement of a customer service agent and a user statement made by a user to respond to such agent statement. For example, the agent statement 210 and the user statement 212 in the conversation 200 may form a dialog pair. It should be understood that a conversation may also include one or more user statements and/or one or more agent statements that do not belong to any dialog pair (e.g., a greeting statement made by a customer service agent at the beginning of a conversation such as the user statement 206, a farewell statement made by a customer service agent or a user at the end of a conversation such as the agent statement 242, etc.).

In some embodiments, each user statement of a user in a conversation may be associated with a user intent that indicates a meaning explicitly or implicitly expressed by the user statement. Because one meaning can be expressed in multiple ways, different user statements may have the same user intent. For example, the user statements “What is my bill,” “How much do I owe?,” and “I want to know my outstanding balance” may have a common user intent of “view bill.” In some embodiments, as a user communicates with a customer service agent in a conversation, the user may make various user statements indicating various user intents. These user intents may form a temporal sequence of user intents corresponding to a chronological order of the conversation. For example, as depicted in FIGS. 2A and 2B, the user 204 may respectively make the user statements 208, 212, 216, 220, 224, 228, 232, 236, and 240 from the beginning to the end of the conversation 200. In this example, the user intents corresponding to these user statements of the user 204 may form a temporal sequence of user intents including a user intent “billing” corresponding to the user statement 208, a user intent “explain my bill” corresponding to the user statement 212, a user intent “explain bill increase” corresponding to the user statement 216, a user intent “obtain account summary” corresponding to the user statement 220, a user intent “view Video On Demand (VOD) list” corresponding to the user statement 224, a user intent “dispute VOD bill” corresponding to the user statement 228, a user intent “define grace period” corresponding to the user statement 232, a user intent “select grace period” corresponding to the user statement 236, and a user intent “end conversation” corresponding to the user statement 240.

In some embodiments, a conversation between a user and a customer service agent may correspond to a resolving action to be performed in order to successfully provide assistance to the user. Non-limiting examples of the resolving action include dispute Internet bill, disable roaming option, set up voicemail, change data plan, etc. Once the resolving action is performed, an issue of the user may be addressed, and therefore a purpose for which the user is communicating with the customer service agent may be fulfilled such that the user is successfully assisted.

In some embodiments, a resolving action may be indicated by a user intent among various user intents of the user in a conversation. For example, a resolving action of the conversation 200 may be indicated by the user intent “dispute VOD bill” corresponding to the user statement 228 in the conversation 200. However, when the user initially communicates with the customer service agent regarding an issue, the user may not know about an underlying cause of the issue and thus may not know about a resolving action to be performed to address the underlying cause. As a result, the resolving action may not be identifiable from user statements made by the user early in the conversation. As an example, early in the conversation 200, the user 204 may communicate with the customer service agent 202 regarding a billing issue related to the user's bill being higher than expected, as depicted in FIG. 2A. The user 204 initially may not know what caused an increase in the bill and thus may not know a resolving action that can be performed to address the issue.

System 100 may generate a conversational flow including agent statements that can guide a conversation to a resolving action quickly. As a result, when a customer service agent conducts a conversation with a user based on the conversation flow, the customer service agent may quickly identify a resolving action for an issue of the user without irrelevant communication back and forth with the user. Once the resolving action is identified, the customer service agent may suggest options and/or provide information about the resolving action to the user, thereby practically addressing the issue of the user in a short and effective conversation.

In some embodiments, system 100 may obtain data representing a set of predetermined resolving actions. For a resolving action in the set of predetermined resolving actions, system 100 may generate a conversational flow for the resolving action. The resolving action for which the conversational flow is generated may be referred to as the resolving action associated with the conversational flow.

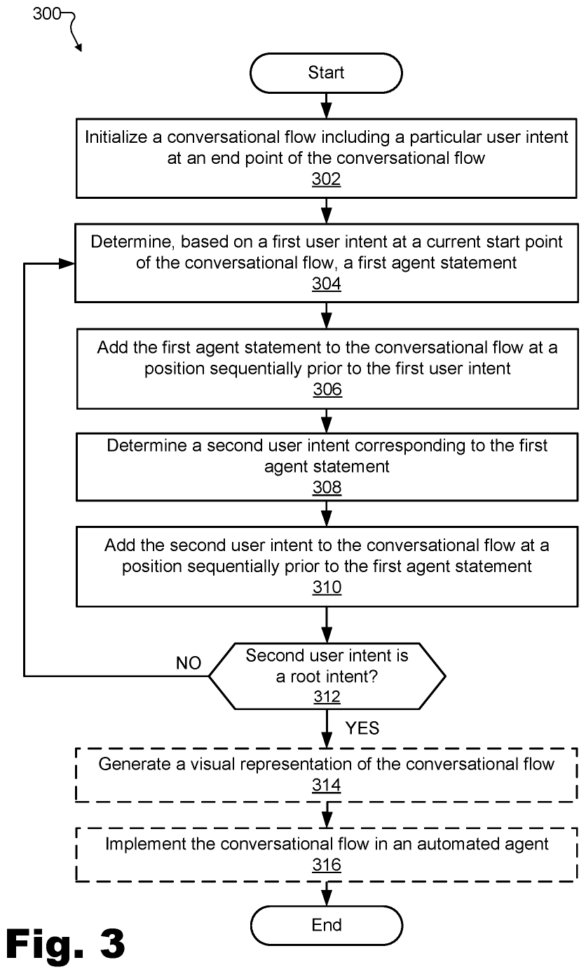

FIG. 3 shows an illustrative conversational flow generation method 300 (method 300) for generating a conversational flow in accordance with principles described herein. While FIG. 3 shows illustrative operations according to one embodiment, other embodiments may omit, add to, reorder, and/or modify any of the operations shown in FIG. 3. In some examples, multiple operations shown in FIG. 3 or described in relation to FIG. 3 may be performed concurrently (e.g., in parallel) with one another, rather than being performed sequentially as illustrated and/or described. One or more of the operations shown in FIG. 3 may be performed by a conversational flow generation system such as system 100 and/or any implementation thereof.

In some embodiments, a conversational flow generated using method 300 may include one or more user intents and one or more agent statements arranged in a sequential order. As an example, a conversational flow may include a first user intent positioned sequentially prior to a first agent statement, and the first agent statement may be positioned sequentially prior to a second user intent. Thus, the conversational flow may include a sequence including the first user intent, the first agent statement, and the second user intent, and a sequential order of these elements may be referred to as a sequential order of the conversational flow. In some embodiments, the sequential order of the conversational flow may indicate and/or be configured to facilitate a chronological order of statements to be made in a conversation that is conducted based on the conversational flow. For example, as the first user intent is positioned sequentially prior to the first agent statement in the conversational flow, a user statement corresponding to the first user intent may occur sequentially prior to the first agent statement in a conversation that is based on the conversational flow. In some embodiments, when a first element (e.g., a user intent or an agent statement) is positioned directly prior to a second element (e.g., an agent statement or a user intent) in a conversational flow without any user intent and/or agent statement in between, the first element may be considered as being located sequentially prior (i.e., immediately prior in a chronological sense) to the second element in the conversation flow, the second element may be considered as being located sequentially subsequent (i.e., immediately subsequent in a chronological sense) to the first element in the conversation flow, and the first element and the second element may be considered as being located sequentially adjacent (i.e., immediately adjacent in a chronological sense) to one another in the conversational flow.

To generate a conversational flow associated with a resolving action, at operation 302, system 100 may initialize the conversational flow to include a particular user intent at an end point of the conversational flow. For example, system 100 may add, at an end point of the conversational flow, a particular user intent that is associated with a desired resolving action for the conversational flow (e.g., a user intent “dispute a VOD bill”). Thus, performance of operation 302 may produce a new conversational flow that initially includes only the particular user intent associated with (e.g., describing and/or configured to lead to) the resolving action at the end point of the conversational flow. Therefore, in the new conversational flow, the particular user intent may also be a current start point of the conversational flow where additional processing on the conversational flow may be performed.

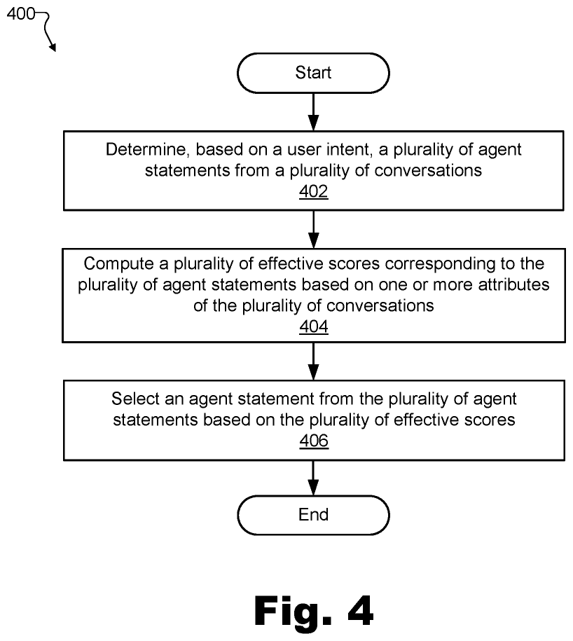

At operation 304, system 100 may determine a first agent statement for the conversational flow based on a first user intent located at the current start point of the conversational flow. System 100 may be configured to determine the first agent statement in any suitable way. An example method for determining an agent statement for a conversational flow based on a user intent is described below with reference to FIG. 4.

Once the first agent statement is selected based on the first user intent at the current start point of the conversational flow, at operation 306, system 100 may add the first agent statement to the conversational flow at a position sequentially prior to the first user intent in the conversational flow. Thus, the first agent statement may be positioned directly prior to the first user intent in the sequential order of the conversational flow without any user intent and/or agent statement in between. When the first agent statement is added to the conversational flow at a position sequentially prior to the first user intent, the first agent statement may become the current start point of the conversational flow where additional processing on the conversational flow may be performed. Therefore, system 100 may update the current start point of the conversational flow to be the first agent statement.

At operation 308, system 100 may determine a second user intent corresponding to the first agent statement. The first agent statement may be made by a customer service agent to respond to the second user intent made by a user, and thus the first agent statement may be responsive to the second user intent. In some embodiments, to determine the second user intent, system 100 may determine one or more user statements to which the first agent statement responded in one or more existing conversations, and determine the second user intent expressed by the one or more user statements. As an example, for a first agent statement “Here is your VOD list,” system 100 may determine that a second user intent corresponding to the first agent statement is “view VOD list.” In some embodiments, system 100 may determine a user intent (e.g., the second user intent) based on an agent statement (e.g., the first agent statement) in a manner similar to determining an agent statement based on a user intent as described herein.

At operation 310, system 100 may add the second user intent to the conversational flow at a position sequentially prior to the first agent statement in the conversational flow. Thus, the second user intent may be positioned directly prior to the first agent statement in the sequential order of the conversational flow without any user intent and/or agent statement in between. When the second user intent is added to the conversational flow at a position sequentially prior to the first agent statement, the second user intent may become the current start point of the conversational flow where additional processing on the conversational flow may be performed. Therefore, system 100 may update the current start point of the conversational flow to be the second user intent.

At operation 312, system 100 may determine whether the second user intent is a root intent. For example, system 100 may compare the second user intent to a predetermined set of root intents. In some embodiments, a root intent may indicate a general topic for which a customer service channel of an organization provides user assistance (e.g., “Internet service,” “billing,” “product care,” etc.), and such a general topic may be a broadest category into which an issue of a user can be categorized. In some embodiments, if a result of the comparison of the second user intent to the predetermined set of root intents indicates that the second user intent does not match any root intent in the predetermined set of root intents, system 100 may accordingly determine that the second user intent at the current start point of the conversational flow does not indicate a general topic of the customer service channel, and therefore may determine that an actual start point of the conversational flow has not been reached and the conversational flow is not completed. In this case, method 300 may proceed to operation 304 to determine another agent statement and another user intent for the conversational flow. Such other agent statement and other user intent may be respectively added to the conversational flow at a position sequentially prior to the current start point of the conversational flow as described above. On the other hand, if the second user intent matches a root intent in the predetermined set of root intents, system 100 may determine that the second user intent at the current start point of the conversational flow indicates a general topic of the customer service channel (e.g., “billing”), and therefore may determine that the second user intent is the actual start point of the conversational flow and the conversational flow is completed.

Thus, to generate a conversational flow, system 100 may start from a particular user intent associated with a resolving action (e.g., a user intent “dispute VOD bill”) at the end point of the conversational flow. System 100 may then recursively determine and add user intent(s) and/or agent statement(s) to the conversational flow at a position sequentially prior to an agent statement or a user intent at the current start point of the conversational flow until the conversational flow includes a user intent matching a predetermined root intent (e.g., billing). System 100 may determine the user intent matching the predetermined root intent to be the actual start point of the conversational flow. Thus, the conversational flow may be generated in an upward manner (e.g., from the end point of the conversational flow to the start point of the conversational flow). This implementation is advantageous at least because it enables system 100 to generate one conversational flow for each resolving action, thereby avoiding a time-consuming and computationally expensive approach that generates multiple candidate conversational flows and evaluates these candidate conversational flows to select one conversational flow to be used.

Moreover, as described below with reference to FIG. 4, system 100 may select agent statements for the conversational flow based on their effective scores, which may be determined based on effectiveness of existing conversations including these agent statements in assisting a user. As a result, the agent statements that are selected and added to the conversational flow may likely facilitate high-quality future conversations that are short, effective, and/or provide positive user experience. Thus, when a customer service agent conducts a conversation with a user based on the conversational flow, the agent statements in the conversational flow may guide the conversation to a resolving action at the end of the conversational flow quickly. Therefore, the customer service agent may quickly identify the resolving action to address an issue for the user without irrelevant communication back and forth with the user, thereby practically addressing the issue of the user in an effective and efficient manner. In addition, the agent statements in the conversational flow may likely provide a positive experience for the user in communicating with the customer service agent during the conversation between the customer service agent and the user.

As depicted in FIG. 3, if system 100 determines at operation 312 that the second user intent is a root intent and thus determines that the conversational flow is completed as described above, method 300 may optionally proceed to operations 314 and 316. The optionality of operations 314 and 316 is represented with dashed lines in FIG. 3.

At operation 314, system 100 may generate a visual representation of the conversational flow. The visual representation of the conversational flow may include one or more user intents and one or more agent statements added to the conversational flow as described above. These user intent(s) and agent statement(s) may be arranged in a sequential order of the conversational flow. At operation 316, system 100 may implement the conversational flow in an automated agent (e.g., a chat bot).

FIG. 4 shows an illustrative method 400 for determining an agent statement for a conversational flow based on a specific user intent in accordance with principles described herein. While FIG. 4 illustrates example operations according to one embodiment, other embodiments may omit, add to, reorder, combine, and/or modify any of the operations shown in FIG. 4. One or more of the operations shown in FIG. 4 may be performed by a conversational flow generation system such as system 100 and/or any implementation thereof.

At operation 402, system 100 may determine a plurality of agent statements from a plurality of conversations based on the specific user intent (e.g., a user intent “dispute VOD bill”). To this end, in some embodiments, system 100 may determine, from existing conversations that are accessible from any suitable source such as a knowledge base including historical conversations, a plurality of conversations that include a user statement associated with the specific user intent. The user statement associated with the specific user intent may be different in different conversations. For example, user statements such as “Why this video is on my list?” “I did not watch it,” “I don't know anything about this one,” etc. in different existing conversations may be determined as being associated with the same user intent (e.g., a user intent “dispute a VOD bill”).

System 100 may be configured to determine user statements associated with the specific user intent in any suitable way. For example, system 100 may be configured to determine user intents for user statements in existing conversations and identify user statements that have determined user intents that match the specific user intent. In some embodiments, to determine a user intent of a user statement in a conversation, system 100 may use a language processing model that is trained with various training examples. Each training example may include a user statement, agent statement(s) sequentially adjacent to the user statement (optional), and a correct user intent explicitly and/or implicitly expressed by the user statement. During a training stage, the language processing model may learn to identify the correct user intent for the user statement in these training examples. Once the training of the language processing model is complete, system 100 may apply the trained language processing model on user statements in a conversation to determine user intents indicated by these user statements. As an example, for the conversation 200, the system 100 may determine that a user intent of the user statement 208 (“Explain my bill”) is “explain my bill,” a user intent of the user statement 216 (“I don't know why my bill last month is so high”) is “explain bill increase,” a user intent of the user statement 220 (“Sure”) is “obtain account summary,” etc. In some embodiments, the language processing model may be implemented by a third-party platform (e.g., DIALOGFLOW, etc.), and system 100 may request and receive a user intent of a user statement from the third-party platform.

In some embodiments, once the plurality of conversations that include user statements associated with the specific user intent are determined, system 100 may determine agent statements that are sequentially prior to the user statements associated with the specific user intent in the plurality of conversations. As an example, for a first conversation including a user statement associated with the specific user intent, system 100 may determine an agent statement located sequentially prior to such user statement in the first conversation. Thus, system 100 may determine a plurality of agent statements that resulted in users making user statements associated with the specific user intent immediately after the customer service agents provided the agent statements in the plurality of conversations. As an example, system 100 may determine a plurality of agent statements that resulted in next user statements being associated with a specific user intent “dispute VOD bill.” The plurality of agent statements may include “Here is your VOD list,” “Do you notice anything strange in your bill?,” “Did your viewing pattern change?,” etc.

At operation 404, system 100 may compute a plurality of effective scores corresponding to the plurality of agent statements in the plurality of conversations based on one or more attributes of the plurality of conversations. Example attributes of a conversation may include, but are not limited to, a performance metric indicating whether a user was successfully assisted during the conversation, a user feedback metric indicating a satisfaction level of the user with the conversation (e.g., 4/5), a conversation duration indicating a time length of the conversation (e.g., 10:03), a conversation time indicating a date and time at which the conversation started (e.g., Jun. 17, 2020 at 14:00:00), etc. These attributes of the conversation may reflect a quality and/or effectiveness of the conversation in assisting a user.

In some embodiments, to compute an effective score for an agent statement in a conversation, system 100 may apply a machine learning model to one or more attributes of the conversation. The machine learning model may be trained with various training examples that may each include a conversation and one or more attributes of the conversation. During a training stage, the machine learning model may learn to compute an effective score for an agent statement in a conversation from these training examples. In particular, the machine learning model may adjust its model parameters (e.g., weight factor associated with each attribute, etc.) to assign an effective score for the agent statement based on values of attributes of the conversation. For example, the machine learning model may learn to assign a relatively high effective score for an agent statement in a conversation that has a positive performance metric (e.g., a user was successfully assisted during the conversation), a positive user feedback metric (e.g., 4/5), a low conversation duration (e.g., 4:20), and/or a conversation time within a peak hour window, etc. As another example, the machine learning model may learn to assign a relatively low effective score for an agent statement in a conversation that has a negative performance metric (e.g., a user was unsuccessfully assisted during the conversation), a negative user feedback metric (e.g., 1/5), a high conversation duration (e.g., 30:10), and/or a conversation time outside the peak hour window, etc. In some embodiments, in addition to the attributes of the conversation, the machine learning model may learn to compute an effective score for the agent statement in the conversation based on other factors such as a relative position of the agent statement within the conversation, a relevance between the agent statement and a resolving action associated with the conversation, etc.

Once the training of the machine learning model is completed, system 100 may apply the trained machine learning model on attributes of a conversation among the plurality of conversations to compute an effective score of an agent statement among the plurality of agent statements that is in the conversation. As described above, the effective score of the agent statement in the conversation may be determined based on attributes reflecting a quality of the conversation in assisting a user, and thus the effective score of the agent statement may indicate a likelihood of the agent statement resulting in a high-quality conversation. In some embodiments, a high-quality conversation may be short and compact (e.g., having a conversation duration satisfying a predetermined duration threshold, such as lower than 5:00), effective (e.g., addressing an issue of a user to successfully assist the user), and/or provide positive user experience (e.g., having user feedback metric satisfying a predetermined feedback metric threshold, such as higher than 3.5/5), etc. It should be understood that other implementations for computing an effective score of an agent statement in a conversation based on attributes of the conversation and/or other factors are also possible and contemplated.

At operation 406, system 100 may select an agent statement from the plurality of agent statements based on the plurality of effective scores corresponding to the plurality of agent statements. As described above, system 100 may compute the plurality of effective scores corresponding to the plurality of agent statements, in which the plurality of agent statements resulted in users making user statements associated with the specific user intent immediately after customer service agents provided these agent statements in the plurality of conversations. In some embodiments, system 100 may select an agent statement that has the highest effective score from the plurality of agent statements. Alternatively, system 100 may select from the plurality of agent statements one or more agent statements that have their effective score satisfying a predetermined effective score threshold (e.g., higher than 0.8), and randomly select an agent statement from the one or more agent statements. Other implementations for selecting an agent statement based on a plurality of effective scores corresponding to a plurality of agent statements are also possible and contemplated. In the above example, system 100 may compute a plurality of effective scores corresponding to a plurality of agent statements that resulted in next user statements being associated with a specific user intent “dispute VOD bill.” System 100 may then select an agent statement “Here is your VOD list” from these agent statements due to its highest effective score among the plurality of effective scores.

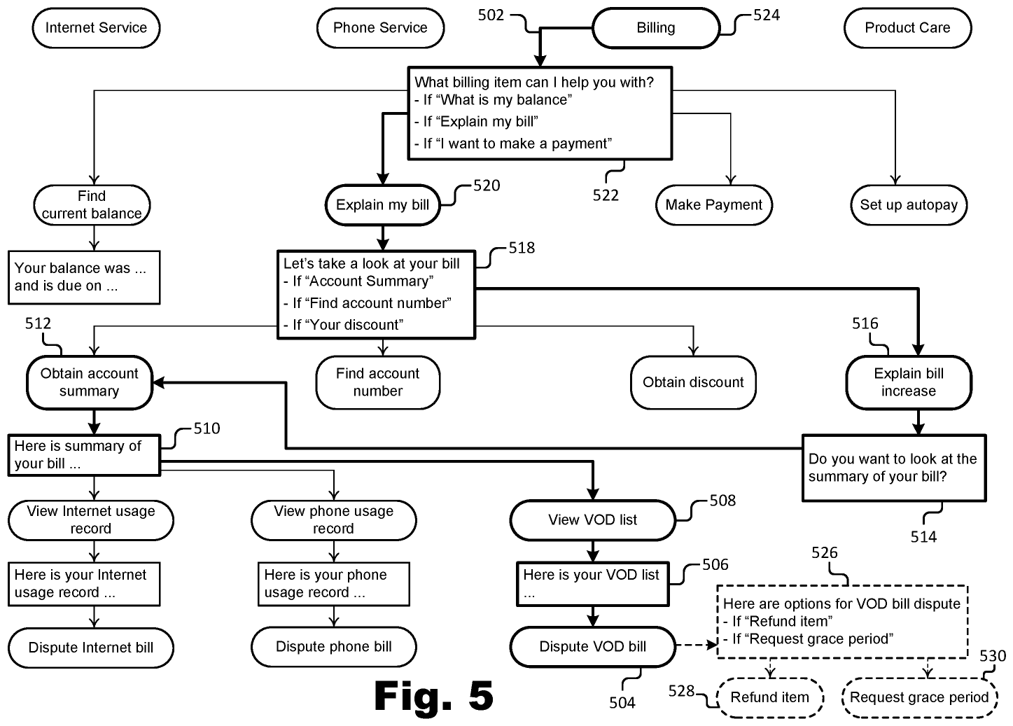

An example visual representation 500 of a conversational flow 502 is illustrated in FIG. 5. Conversational flow 502 may be generated in any of the ways described herein. As depicted in FIG. 5, the conversational flow 502 may include a user intent 504 (e.g., “dispute VOD bill”) indicating a resolving action at the end point of the conversational flow 502. The conversational flow 502 may also include an agent statement 506, a user intent 508, an agent statement 510, a user intent 512, an agent statement 514, a user intent 516, an agent statement 518, a user intent 520, an agent statement 522, and a user intent 524 (e.g., “billing”) that is a root intent at the start point of the conversational flow 502. When the conversational flow 502 is generated, the user intents and agent statements may be respectively added to the conversational flow 502 dynamically and in an upward manner from the end point of the conversational flow 502 to the start point of the conversational flow 502 as described above.

In some embodiments, a customer service agent may conduct a conversation with a user based on the conversational flow 502. To conduct the conversation with the user, the customer service agent may follow the conversational flow 502 in a downward manner from the start point of the conversational flow 502 to the end point of the conversational flow 502. For example, the customer service agent may sequentially make the agent statements 522, 518, 514, 510, 506 to respectively respond to user statements associated with the user intents 524, 520, 516, 512, 508 in the conversation, thereby quickly guiding the conversation to the resolving action corresponding to the user intent 504 at the end point of the conversational flow 502. In this example, the user may make a user statement (e.g., “I have no idea why that video is on my list”) in the conversation, and the customer service agent may determine that such user statement has a user intent of “dispute VOD bill.” As a result, the customer service agent may determine that the conversation has arrived at the user intent 504 (e.g., “dispute VOD bill”) at the end point of the conversational flow 502, and thus identify a resolving action corresponding to the conversation to be “dispute VOD bill” as indicated by the user intent 504.

Once the resolving action is identified, the customer service agent may continue the conversation based on the resolving action to practically address an issue for the user. For example, the customer service agent may make agent statements to suggest one or more available options to perform the resolving action to the user such as:
Here are some options for you. Which option do you want to proceed with?
A) Refund item
B) Request grace period.

The customer service agent may also provide detailed information about these available options to the user upon a user request for the detailed information (e.g., “It usually takes 3-5 business days for the refund amount to show up in your account,” “Grace period gives you additional 24 hours to watch the content item,” etc.), receive a selected option to perform the resolving action from the user (e.g., requesting grace period), and/or update a current status of the resolving action for the user as the resolving action is performed based on the selected option (e.g., “I have started a grace period for ‘Knives Out.’ This grace period started at 10:03 pm today and will end at 10:03 pm tomorrow.”), etc.

In some embodiments, a conversational flow generated by the system 100 may optionally include one or more agent statements and one or more user intents based on which the customer service agent may communicate with the user about the resolving action. These agent statements and user intents may be added to the conversational flow in a chronological order at positions subsequent to a user intent associated with the resolving action at the end point of the conversational flow. For example, as depicted in FIG. 5, the conversational flow 502 may optionally include an agent statement 526 and user intents 528 and 530 related to available options to perform a resolving action “dispute VOD bill.” These agent statement and user intents may be positioned subsequent to the user intent 504 that indicates this resolving action at the end point of the conversational flow 502.

In some embodiments, system 100 may display a visual representation of a conversational flow to a representative of an organization that provides a customer service channel (e.g., a manager and/or an administrator of the organization). For example, system 100 may display the visual representation of the conversational flow on a display device such as a display screen. In some embodiments, the visual representation of the conversational flow may visually illustrate a temporal structure of the conversational flow with user intents indicated by user statements and agent statements that may be used to respond to these user statements in a conversation, thereby facilitating the representative of the organization in evaluating and/or adjusting the conversational flow before the conversational flow is provided for use by customer service agents. For example, the representative of the organization may adjust an agent statement in the conversational flow to present an option to request a grace period before an option to refund an item for a resolving action “dispute VOD bill,” thereby promoting the option to request a grace period over the option to refund an item.

In some embodiments, the visual representation of the conversational flow may include multiple agent statements and multiple user intents among which agent statements and user intents belonging to the conversational flow and their sequential order are emphasized (e.g., highlighted, displayed in a different format, etc.) as depicted in FIG. 5. Alternatively, the visual representation of the conversational flow may include only agent statements and user intents belonging to the conversational flow that are arranged in a sequential order of the conversational flow.

In some embodiments, system 100 may provide a generated conversational flow to customer service agents, and the customer service agents may conduct conversations with users based on the conversational flow. For example, to respond to a user statement made by a user in a conversation, a human agent may determine a user intent associated with the user statement, reference the conversational flow to determine an agent statement that is sequentially subsequent to the user intent associated with the user statement in the conversational flow, and respond to the user statement with such agent statement. Additionally and/or alternatively, system 100 may implement the conversational flow in an automated agent, and the automated agent may follow the conversational flow in conversations with users. For example, to respond to a user statement made by a user in a conversation, the automated agent may determine a user intent associated with the user statement, and automatically respond to the user statement with an agent statement that is sequentially subsequent to the user intent associated with the user statement in the conversational flow.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

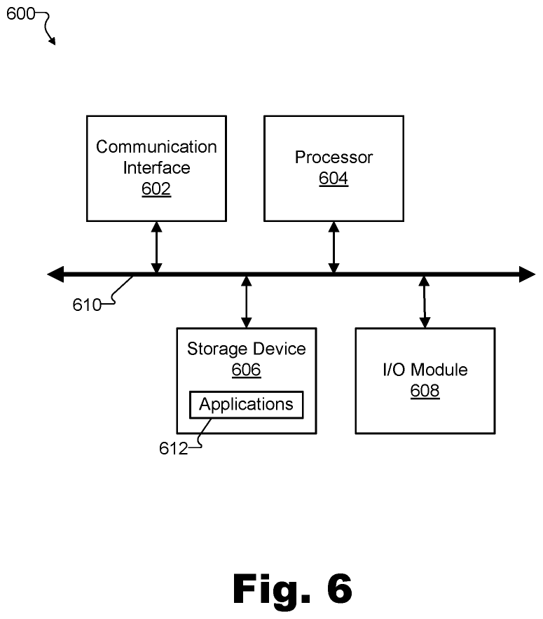

FIG. 6 shows an illustrative computing device 600 that may be specifically configured to perform one or more of the processes described herein. For example, computing device 600 may include or implement (or partially implement) a conversational flow generation system such as system 100, a display device, and/or any other computing devices described herein.

As shown in FIG. 6, computing device 600 may include a communication interface 602, a processor 604, a storage device 606, and an input/output (“I/O”) module 608 communicatively connected via a communication infrastructure 610. While an illustrative computing device 600 is shown in FIG. 6, the components illustrated in FIG. 6 are not intended to be limiting. Additional or alternative components may be used in other embodiments. Components of computing device 600 shown in FIG. 6 will now be described in additional detail.

Communication interface 602 may be configured to communicate with one or more computing devices. Examples of communication interface 602 include, without limitation, a wired network interface (such as a network interface card), a wireless network interface (such as a wireless network interface card), a modem, an audio/video connection, and any other suitable interface.

Processor 604 generally represents any type or form of processing unit capable of processing data or interpreting, executing, and/or directing execution of one or more of the instructions, processes, and/or operations described herein. Processor 604 may direct execution of operations in accordance with one or more applications 612 or other computer-executable instructions such as may be stored in storage device 606 or another computer-readable medium.

Storage device 606 may include one or more data storage media, devices, or configurations and may employ any type, form, and combination of data storage media and/or device. For example, storage device 606 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 606. For example, data representative of one or more executable applications 612 configured to direct processor 604 to perform any of the operations described herein may be stored within storage device 606. In some examples, data may be arranged in one or more databases residing within storage device 606.

I/O module 608 may include one or more I/O modules configured to receive user input and provide user output. One or more I/O modules may be used to receive input for a single virtual experience. I/O module 608 may include any hardware, firmware, software, or combination thereof supportive of input and output capabilities. For example, I/O module 608 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 608 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 600. For example, one or more applications 612 residing within storage device 606 may be configured to direct processor 604 to perform one or more processes or functions associated with processor 104 of system 100. Likewise, memory 102 of system 100 may be implemented by or within storage device 606.

To the extent the aforementioned embodiments collect, store, and/or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various illustrative embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
adding, by a conversational flow generation system, a user intent to a conversational flow;
determining, by the conversational flow generation system and based on the user intent, a plurality of agent statements from a plurality of conversations;
selecting, by the conversational flow generation system, an agent statement from the plurality of agent statements; and
adding, by the conversational flow generation system, the agent statement to the conversational flow at a position sequentially prior to the user intent in the conversational flow.

2. The method of claim 1, wherein:
the user intent is located at a current start point of the conversational flow; and
the method further comprises updating, responsive to adding the agent statement to the conversational flow, the current start point of the conversational flow to be the agent statement.

3. The method of claim 1, wherein determining the plurality of agent statements from the plurality of conversations includes:
determining that a particular conversation includes a user statement associated with the user intent; and
determining a particular agent statement sequentially prior to the user statement in the particular conversation.

4. The method of claim 1, wherein selecting the agent statement from the plurality of agent statements includes:
computing a plurality of effective scores corresponding to the plurality of agent statements based on one or more attributes of the plurality of conversations; and
selecting, from the plurality of agent statements, the agent statement based on the plurality of effective scores corresponding to the plurality of agent statements.

5. The method of claim 4, wherein computing the plurality of effective scores corresponding to the plurality of agent statements includes:
applying a machine learning model to the one or more attributes of a particular conversation among the plurality of conversations to compute an effective score corresponding to a particular agent statement among the plurality of agent statements that is in the particular conversation.

6. The method of claim 4, wherein the one or more attributes of a particular conversation among the plurality of conversations include at least one of a performance metric, a user feedback, a conversation duration, a conversation date, or a conversation time associated with the particular conversation.

7. The method of claim 1, further comprising:
generating a visual representation of the conversational flow, the visual representation including one or more agent statements and one or more user intents in the conversational flow arranged in a sequential order of the conversational flow; and
displaying the visual representation of the conversational flow on a display device.

8. The method of claim 1, further comprising:
implementing the conversational flow in an automated agent, the automated agent following the conversational flow in a conversation with a user.

9. The method of claim 1, embodied as computer-executable instructions on a non-transitory computer-readable medium.

10. A system comprising:
a processor communicatively coupled to memory and configured to execute instructions to:
add a user intent to a conversational flow;
determine, based on the user intent, a plurality of agent statements from a plurality of conversations;
select an agent statement from the plurality of agent statements; and
add the agent statement to the conversational flow at a position sequentially prior to the user intent in the conversational flow.

11. The system of claim 10, wherein:
the user intent is located at a current start point of the conversational flow; and
the processor is further configured to execute the instructions to update, responsive to adding the agent statement to the conversational flow, the current start point of the conversational flow to be the agent statement.

12. The system of claim 10, wherein the determining of the plurality of agent statements from the plurality of conversations includes:
determining that a particular conversation includes a user statement associated with the user intent; and
determining a particular agent statement sequentially prior to the user statement in the particular conversation.

13. The system of claim 10, wherein the selecting of the agent statement from the plurality of agent statements includes:
computing a plurality of effective scores corresponding to the plurality of agent statements based on one or more attributes of the plurality of conversations; and
selecting, from the plurality of agent statements, the agent statement based on the plurality of effective scores corresponding to the plurality of agent statements.

14. The system of claim 13, wherein the computing of the plurality of effective scores corresponding to the plurality of agent statements includes:
applying a machine learning model to the one or more attributes of a particular conversation among the plurality of conversations to compute an effective score corresponding to a particular agent statement among the plurality of agent statements that is in the particular conversation.

15. The system of claim 13, wherein the one or more attributes of a particular conversation among the plurality of conversations include at least one of a performance metric, a user feedback, a conversation duration, a conversation date, or a conversation time associated with the particular conversation.

16. The system of claim 10, wherein the processor is further configured to execute the instructions to:
generate a visual representation of the conversational flow, the visual representation including one or more agent statements and one or more user intents in the conversational flow arranged in a sequential order of the conversational flow; and
provide the visual representation of the conversational flow for display by a display device.

17. The system of claim 10, wherein the processor is further configured to execute the instructions to:
implement the conversational flow in an automated agent, the automated agent following the conversational flow in a conversation with a user.

18. A method comprising:
initializing, by a conversational flow generation system, a conversational flow including a first user intent at an end point of the conversational flow;
determining, by the conversational flow generation system and based on the first user intent, a plurality of first agent statements from a plurality of first conversations;
selecting, by the conversational flow generation system, a first agent statement from the plurality of first agent statements;
adding, by the conversational flow generation system, the first agent statement to the conversational flow at a position sequentially prior to the first user intent in the conversational flow;
determining, by the conversational flow generation system, a second user intent corresponding to the first agent statement;
adding, by the conversational flow generation system, the second user intent to the conversational flow at a position sequentially prior to the first agent statement in the conversational flow;
determining, by the conversational flow generation system and based on the second user intent, a plurality of second agent statements from a plurality of second conversations;
selecting, by the conversational flow generation system, a second agent statement from the plurality of second agent statements; and
adding, by the conversational flow generation system, the second agent statement to the conversational flow at a position sequentially prior to the second user intent in the conversational flow.

19. The method of claim 18, wherein determining the plurality of first agent statements from the plurality of first conversations includes:
determining that a particular conversation includes a user statement associated with the first user intent; and
determining a particular agent statement sequentially prior to the user statement in the particular conversation.

20. The method of claim 18, wherein selecting the first agent statement from the plurality of first agent statements includes:
computing a plurality of effective scores corresponding to the plurality of first agent statements based on one or more attributes of the plurality of first conversations; and
selecting, from the plurality of first agent statements, the first agent statement based on the plurality of effective scores corresponding to the plurality of first agent statements.
